(19) United States
(12) Patent Application Publication
(10) Pub. No.: US 2016/0249641 A1
(43) Pub. Date: Sep. 1, 2016

(54) METHODS OF FORMULATING FEEDS FOR YOUNG ANIMALS AND METHODS OF FEEDING SAME

(71) Applicant: Milk Products LLC, Chilton, WI (US)

(72) Inventor: Julian Olson, Highland Village, TX (US)

(21) Appl. No.: 14/645,071

(22) Filed: Mar. 11, 2015

Related U.S. Application Data
(63) Continuation-in-part of application No. 14/634,317, filed on Feb. 27, 2015.

(51) Int. Cl. A23K 1/18

(52) U.S. Cl. CPC A23K 1/1893

(57) ABSTRACT

Whole milk and at least one additional nutrient source are admixed to reach a target diet and the amount of each of the admixture components is calculated based on compositional analysis results of the available whole milk, known levels of nutrients in the additional nutrient source, and the dietary target(s) for the young animals. The compositional analysis and admixing may be performed at the location where the young animals are fed.

### CROSS-REFERENCE TO RELATED APPLICATION

This application is a continuation-in-part of U.S. patent application Ser. No. 14/634,317 filed on Feb. 27, 2015, the content of which is incorporated herein by reference in its entirety.

### TECHNICAL FIELD

The present disclosure relates generally to methods of formulating diets for feeding young animals, and more particularly to formulating liquid rations containing an admixture of whole milk and additional nutrient sources according to one or more dietary targets.

### BACKGROUND

Livestock animals are a commodity and are raised to produce milk and meat. The time it takes livestock to mature, particularly to gain weight, is important when assessing whether the animal is ready to produce milk or is ready for market. A number of feeding systems have been used to enhance weight gain of livestock beginning at a young age, and may include feeding techniques prior to and after weaning. Such techniques may involve providing milk replacers to the animals that generally mimic the milk produced from the post-partum parent animal in terms of protein, fat and carbohydrate content. The milk replacer may be supplemented with vitamins, minerals, medication and other compositions that may benefit the young animals. This may, for example, reduce the age of freshening or the onset of lactation of a dairy cow, thereby reducing the cost of milk production. Increased weight gain of livestock from an early age may also reduce the cost of beef production.

A concern for producers is whether livestock animals are receiving adequate nutrients. When the livestock animals refuse feed, intake is decreased, which may be problematic from both the standpoint of the health of the animal and to the cost of milk or meat production. Differences in feed intake by animals impact rate of weight gain and ultimately body size. Smaller animals are more difficult to adequately manage due to their specific housing, dietary and husbandry needs.

Although various feeding systems have been practiced to enhance weight gain, these feeding systems have not optimized methods for increasing the rate and uniformity of weight gain by the livestock animals from a young age. Accordingly, producers are in need of new approaches to feeding young livestock animals as well as other young animals that enhance weight gain rates and/or increase feed efficiency.

### SUMMARY

According to one implementation, a method of formulating a diet for a young animal in a feeding program involves, in a location where young animals are fed, analyzing available whole milk for a level of total solids, protein as a percentage of total solids and fat as a percentage of total solids, and determining a volume of whole milk available for feeding to the young animal; identifying a diet to be fed to the young animal, the diet including a total solids target and/or fat as a percentage of total solids target and/or a protein as a percentage of total solids target, where the target is different from a corresponding level of total solids, fat or protein in the analyzed whole milk. The analysis results of the analyzed whole milk are used to calculate an amount of at least one additional nutrient source for incorporating with the available whole milk to reach the at least one target, and an amount of water for incorporating with the available whole milk to reach the at least one target is calculated. The calculated amounts of the at least one additional nutrient source and water are admixed with the whole milk in the location to reach the at least one target. The admixture is fed to the young animal. Over the course of the program, the compositional analysis results of the available whole milk or an available volume of the whole milk varies such that the amounts calculated dynamically change.

According to a second implementation, a method of formulating a target diet for a young animal in a feeding program involves, in a location where young animals are fed, analyzing available whole milk for a level of total solids, protein as a percentage of total solids and fat as a percentage of total solids, and determining a volume of whole milk available for feeding to the young animal. A diet to be fed to the young animal is identified that includes a total solids target that is different from the total solids in the analyzed whole milk. The analysis results of the analyzed whole milk is used to calculate an amount of at least one additional nutrient source for incorporating with the available whole milk to reach the total solids target, and an amount of water for incorporating with the available whole milk to reach the total solids target is calculated. The calculated amounts of the at least one additional nutrient source and water with at least a portion of the available volume of whole milk are admixed in the location to reach the total solids target. The method may further involve feeding the admixture to the young animal. Over the course of the program, the compositional analysis results of the available whole milk or an available volume of the whole milk varies such that the amounts calculated dynamically change.

According to a third implementation, a method of formulating liquid feed for a calf nutrition program for a group of calves involves receiving compositional analysis results of available whole milk, where the compositional analysis results include at least two of total solids, protein as a percentage of total solids and fat as a percentage of total solids, density, added water or lactose; calculating an amount of an additional nutrient source for incorporating with the available whole milk to reach a dietary target, the dietary target including at least two targets selected from total solids, protein as a percentage of total solids and fat as a percentage of total solids or lactose, and the additional nutrient source comprising one or more of a milk replacer, an extender, a fortifier, or a balancer; and mixing the calculated amount of the additional nutrient source with the available whole milk to reach the dietary target, where, over the course of the program, the compositional analysis results of the available whole milk or an available amount of the available whole milk varies such that the amount calculated dynamically changes.

In additional or alternative implementations, the at least one target includes each of the total solids target, the fat as a percentage of total solids target and the protein as a percentage of total solids target, and at least one of these targets is different from a corresponding level of total solids, fat or protein in the whole milk. In such implementations, the at least one additional nutrient source may be a first additional nutrient source having an elevated fat content and a second additional nutrient source having an elevated protein content such that the first nutrient source is compositionally different from the second nutrient source, and the calculated amount of the at least one additional nutrient source comprises an amount of each of the first and second nutrient sources. In some cases the additional nutrient source is a milk replacer.

In additional or alternative implementations, the step of analyzing uses an ultrasonic analyzer.

In additional or alternative implementations, in connection with the second implementation, the target may further include a fat as a percentage of total solids target and/or a protein as a percentage of total solids target. In this case, the at least one additional nutrient source may include a first additional nutrient source having an elevated fat content and a second additional nutrient source having an elevated protein content, wherein a composition of the first nutrient source is different from the second nutrient source, and wherein the calculated amount of the at least one additional nutrient source comprises an amount of each of the first and second nutrient sources. In some cases the additional nutrient source is a milk replacer.

In additional or alternative implementations, a nutrient requirement of the animal in the program changes over the course of the program such that the diet dynamically changes.

In additional or alternative implementations, the additional nutrient source includes an extender with a blend of protein and fat.

In additional or alternative implementations, the additional nutrient source includes a fortifier with a blend of vitamins and minerals.

In additional or alternative implementations, the additional nutrient source includes a balancer with a blend of protein and fat in which a protein level is different from a fat level.

In additional or alternative implementations, the number of calves in the group of calves changes over the course of the program such that amounts mixed dynamically changes.

### BRIEF DESCRIPTION OF THE DRAWINGS

FIGS. 1-9 provide exemplary screen shots of an embodiment that may be used to display information related to calculating a feed ration or target diet for the young animals, according to certain implementations.

FIG. 10 provides a block diagram of a computer system used calculate a feed ration or target diet for the young animal(s) and displaying the information on a visual display, according to certain implementations.

### DETAILED DESCRIPTION

Overview

The methods of formulating liquid diets and of feeding liquid diets of the present disclosure are applicable to young animals such as calves, lambs, kids, other young ruminants, piglets, other young livestock animals, foals, young zoo animals and young companion animals. In addition, the young animals may be fed individually or in a group setting. At the beginning stages of life young animals rely solely or heavily on a liquid diet for delivering dietary nutrients required to survive, maintain and/or grow. Eventually the young animal is weaned from the liquid diet and ingests solid feed, such as forage and grains in the case of livestock animals including ruminants. Prior to being weaned, the animal may ingest a primarily liquid diet while intaking feed such as starter feed. The present disclosure is applicable to formulating liquid diets for young animals prior to and during weaning. It has been found that liquid diets that take into account the nutrients contained in whole milk fed to the young animal, as well as the nutrients contained in milk replacers, extenders, balancers and/or fortifiers provide a targeted approach to achieving a desired animal performance in the young animal.

In prior approaches, young animals separated from their mother at birth are fed milk replacers for nourishment until the animals are weaned. Milk replacers typically contain a blend of protein and fat in an amount that mimics milk produced by the female of the species. These milk replacers are known as conventional milk replacers and they generally contain less than 25 percent protein by dry weight and are fed in conventional settings, e.g., at a rate of up to about 1.5 pounds per head/day on a dry weight basis. Most conventional milk replacers contain all-milk proteins that are typically derived from cow's milk. Some conventional milk replacers contain non-milk proteins from other sources.

In other approaches, young animals in these settings are fed high potential milk replacers that typically contain at least 25 percent protein by dry weight, which may be provided by milk proteins, non-milk proteins or a combination of non-milk proteins and milk proteins. Full potential milk replacers are commonly fed in enhanced settings, e.g., at a rate of about 1.6 pounds per head/day on a dry weight basis.

In each of these prior approaches, young animals are offered starter feed, which is a solid feed containing a mixture of grains and nutrients, that the animal ingests ad libitum. The rate of ingestion of starter feed is generally low during the first few weeks of life and gradually increases through weaning as the animal naturally transitions from an all liquid diet to solids diet comprised of forages and grains. Starter feed may contain about 18 to about 22 percent crude protein, may be texturized, pelleted and/or medicated.

In still other approaches, young animals are fed whole milk and offered starter feed. According to the present disclosure, feeding systems that use whole milk mean the milk is liquid milk that remains in its naturally liquid state. This is opposed to feeding systems where animals are fed reconstituted milk products (e.g., milk replacers) where milk powders are rehydrated using water. This is also opposed to young animals ingesting milk by suckling from a lactating animal. In its initial state, whole milk is generally free of additives tailored for the young animal, such as milk replacers, balancers, extenders and fortifiers. While the whole milk is generally derived from the same species of animal ingesting the whole milk, this is not a requirement of the present disclosure. Most commonly, young animals are fed whole milk derived from a dairy cow, and while the young animals may be calves (e.g., that eventually mature into dairy cows, bulls or steers), other young animals, such as the broader category of young ruminants, may ingest whole milk prior to weaning. Whole milk may generally be of two different types: saleable milk and non-saleable milk including hospital milk.

Saleable milk is milk that is suitable for selling for human consumption but the producer has chosen to feed the young animals. For instance, saleable milk may be wholesome milk from the cow prior to shipping to a processor. Saleable milk may also be skim milk, 1 percent fat milk, 2 percent fat milk, 4 percent fat milk or combinations thereof that the producer purchases from a retail grocery, wholesale supplier or processor as homogenized milk that has a short expiration date. When saleable milk is located at the producer's facility, the milk may be comingled, meaning the milk total solids, fat and protein levels are unknown.

Non-saleable milk can include squeeze milk, or milk that has passed its shelf-life hut is otherwise edible and has been removed from retail sale. Squeeze milk may be obtained by producers through shipments that deliver this milk product. Squeeze milk may be co-mingled when containers are placed in a compression chamber that crushes the containers and collects the milk (hence the term squeeze milk), Other types of non-saleable milk may include milk found with violative residues or that has not passed other inspections such as freezing point depression after it has left the farm hut before co-mingling at the milk processor location. Hospital milk is milk that is non-saleable and not suitable for human consumption. It may include colostrum, transition milk, mastitic milk, antibiotic treated milk, i.e. milk from antibiotic treated animals, or high somatic cell count milk.

In prior approaches where the young animals were fed whole milk, producers generally add a fixed amount of a fortifier to ensure the young animal ingests vitamins nutrients and medications required for the animal to grow and stay healthy. The young animal diet tended to be variable in nutritional content, however, the fortifier helped ensure that the young animal remained healthy until the animal was weaned. This approach to feeding young animals can present problems for the animal's overall growth and ability to thrive during adulthood.

Accordingly, the present disclosure provides methods for tailoring the diet of the whole milk-fed young animal by calculating a feed ration for the young animal that includes an admixture of whole milk and additional nutrients incorporated at specific levels in order to feed the young animal a target diet. The methods may be used to deliver a constant level of total solids and nutrients, such as fat and protein. The methods may be performed during the course of a daily feeding program for the young animal or animals, and the steps of the methods may be performed frequently over the course of the program, such as daily; every other day; or multiple times per week, e.g., bi-weekly. The feeding program may last to weaning or until the animal is weaned, which may be about 8 weeks from birth, or the program may end when the animal no longer ingests a diet containing whole milk. Further, the formulation and feeding methods may be performed at a location where the young animals are fed, such as on a farm, ranch or within a research facility.

Exemplary Methods of Formulating Feed Compositions and Feeding Young Animals

Methods involve determining the composition of the whole milk to be fed to the young animal. The composition may include one or more of total solids, fat (e.g., fat as a percentage of total solids), protein (e.g., protein as a percentage of total solids), density, added water and/or lactose (e.g., lactose as a percentage of total solids) present in the whole milk. The composition may be known for some whole milk products, such as whole milk produced by dairy cows present on a farm where young animals are to be fed.

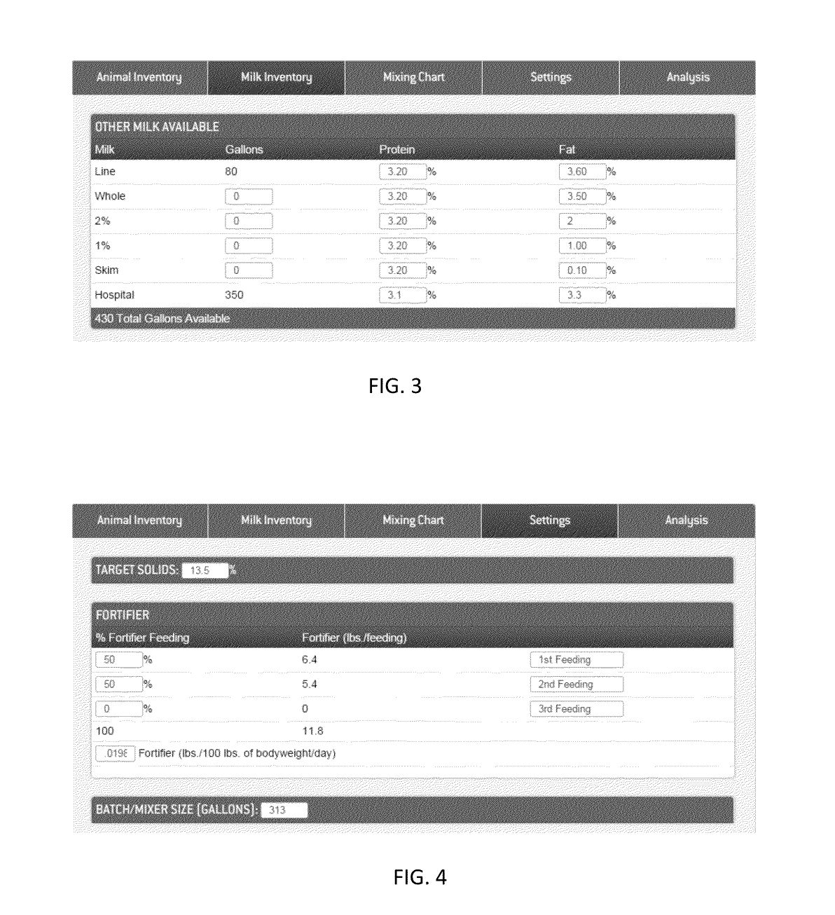

In other approaches, the composition of the whole milk is unknown, such as when the whole milk is delivered in bulk or when the whole milk is comingled from a number of sources. For instance, non-saleable, squeeze milk may be provided as a mixture of skim, 1 percent, 2 percent and/or 4 percent milk resulting in a variable fat content and variable protein to fat ratio. In another example, hospital milk may be comingled so that the whole milk contains an admixture of colostrum (e.g., containing about 25 percent total solids), fresh milk (e.g., containing about 18 percent total solids) and/or milk produced during normal lactation (e.g., containing about 12.5 percent total solids). Further, water used to flush lines may reach the milk stream. Consequently, whole milk may have a variable total solids content of about 7 to about 15 percent. Accordingly, in some implementations, the whole milk composition is estimated or determined using an electronic analyzer that uses ultrasonics, refractometry, near infrared spectrometry (NIR) or variations and combinations thereof. The analyzer may determine the total solids, fat, protein, density, added water and/or lactose present in the whole milk. In some approaches, bench chemistry may additionally or alternatively be used in the compositional analysis. In some preferred approaches, the electronic analyzer is present at the location where the young animals are fed and therefore may be referred to as an on farm analyzer. Particularly, the use of analytical methods at the location where the young animals are fed gives the producer or nutritionist the ability to understand the composition of the whole milk available at any given time and tailor and target the feed ration of the young animal or animals using available additional nutrient sources. In addition or alternatively, the electronic analyzer may preferably be a refractometer adapted to estimate total solids using the brix scale. In addition or alternatively, the electronic analyzer may more preferably be an ultrasonic analyzer. Such analyzers collect a milk sample (e.g., in an ultrasonic chamber), prepare the milk sample for analysis (e.g., by heating), and deliver ultrasonic pulses to the milk that are sensed by sensors communicatively coupled to a microprocessor. The sensors sense temperature and time readings based on the ultrasonic pulses transmitted through the milk in order to correlate the readings with actual total solids, fat, protein, density, added water and/or lactose in the sample. Analysis results may be displayed on a standalone analyzer, may be printed, stored or used for further calculations or analysis, and/or or may be displayed on a display screen communicatively coupled to the analyzer, such as a computer specially programmed to receive the analysis results. FIGS. 2-3 discussed herein depict exemplary user interfaces that may be used to display test results.

The whole milk composition may be compared to dietary targets identified for the young animal. Dietary targets generally include a volume of liquid nutrients to be fed per animal per day as well as target total solids and nutrient content to be fed to the animal on a daily basis. For instance, each animal may be fed a volume of about 1.5 to 3.5 liters of liquid per feeding, and the total volume may be delivered once per day, or may be provided into two to three meals or more per day (e.g., up to 10 meals per day when the animal is fed using an automatic feeder). On a dry matter basis, the dietary target may be formulated so that the animal is offered a liquid diet that contains about 0.50 pounds to about 3.0 pounds of total solids per day on a dry matter basis, including but not limited to 0.5, 0.75, 1.0, 1.25, 1.5, 1.75, 2.0, 2.25, 2.5, 2.75 or 3.0 pounds of total solids per animal per day on a dry matter basis. In some preferred approaches, the dietary target may include at least about 1.0 pounds of total solids on a dry matter basis per animal per day up until weaning, or more preferably at least about 1.5 pounds per animal per day. At the onset of weaning and until the young animal is weaned, at least 0.75 pounds of total solids per animal per day may be preferred. The total solids may comprise nutrients such as fat, protein, lactose and ash.

In some implementations, the target diet may include about 10 to about 17 percent total solids on a dry matter basis, including but not limited to 10-14, 11-14, 12-14, 10-15, 11-15, 12-15, 10-16, 11-16, 12-16, 11-17, 12-17, 10, 11, 112, 13, 14, 15, 16 or 17 percent total solids on a dry matter basis. For example, for weaning animals, the target total solids may be about 10-11 percent on a dry matter basis; for pre-weaning animals, the target total solids may be about 12-14 percent on a dry matter basis; for enhanced feeding settings, the target total solids may be about 15-17 percent on a dry matter basis.

A target protein content may be about 20 to about 26 percent of the total solids on a dry matter basis, including but not limited to about 20-25, 20-24, 20-23, 20-22, 21-26, 21-25, 21-24, 21-23, 22-26, 22-25, 22-24, 23-26, 23-25, 24-26, 20, 21, 22, 23, 24, 25 or 26 percent protein as a percent of total solids on a dry matter basis.

A target fat content may be about 16 to about 25 percent of the total solids on a dry matter basis, including but not limited to about 16-24, 16-23, 16-22, 16-21, 16-20, 16-19, 16-18, 18-25, 18-24, 18-22, 18-20, 20-25, 20-24, 20-22, 16, 17, 18, 19, 20, 21, 22, 23, 24 or 25 percent protein as a percent of the total solids on a dry matter basis.

The dietary targets may be selected or identified based on a growth goal that the producer or nutritionist has for the young animal(s). For instance, in traditional settings, young animals may be fed at a lower feeding rate so that the animal grows nominally in size and weight. In another example, in enhanced settings, young animals may be fed at an enhanced feeding rate to achieve elevated growth in frame size and weight. According to a particular aspect of the present disclosure, the young animals may be fed at a selected protein and fat level and a selected ratio of whole milk to additional nutrients that results in the young animals ingesting starter feed at an enhanced rate in order to achieve improved performance such as improved feed intake, gain in frame size and/or weight gain. According to this aspect, a dietary target of about 0.75 lbs. total solids per feeding, with protein at about 24 to about 26 percent total solids and fat at about 18 to about 22 percent of total solids; where at least about 0.50 lbs. of the total solids is from whole milk and the remainder from an admixed additional nutrient source, such as a high protein content milk replacer or balancer.

Based on the comparison of the whole milk composition and the dietary target, one or more additional nutrients may be identified for use in combination with the whole milk. The additional nutrients may contain protein, fat, lactose, other solids such as ash, vitamins, minerals, medications or combinations thereof. The additional nutrients may be in powder or liquid form and may be adapted for being incorporated in an aqueous solution. In some preferred approaches, the additional nutrients are in powder form, The additional nutrients may be contained within a milk replacer, an extender, a fortifier or a balancer. In some implementations, a milk replacer may serve as an extender and/or as a balancer. For instance, a milk replacer that contains 20 percent protein and 20 percent fat of total solids may serve as an extender, while a milk replacer that contains 25 percent protein and 10 percent fat of total solids may serve as a balancer. Protein in milk replacers may be all milk proteins, plant-based proteins or a combination. Fat in milk replacers may be derived from. milk, lard, tallow, vegetable oils or a combination.

Extenders generally add volume and a similar or equal level of nutrients (e.g., near equal or equal amounts of fat and protein) to the whole milk-based diet of the animal. Extenders may contain about 20 to 22 percent protein of total solids, including but not limited to 20, 21 or 22 percent protein and about 18 to about 20 percent fat of total solids, including but not limited to about 18, 19 or 20 percent fat. Fortifiers generally add vitamins, minerals, nutrients and/or medications to the diet of the animal but typically are provided in amounts that are relatively insignificant for purposes of increasing volume. Balancers generally add both volume and balance nutrients in the whole-milk based diet of the animal. For instance, where an elevated protein level relative to a fat level needed to reach the target diet, the balancer may contain more protein than fat, to reach a target feeding level such as 26 percent protein and 20 percent fat of total solids. Balancers contain about 23 to about 25 percent protein of total solids, including but not limited to about 23, 24 or 25 percent protein, and about 7 to about 10 percent fat of total solids, including but not limited to about 7, 8, 9, or 10 percent fat, and generally contain unequal amounts of these nutrients. In alternative examples, balancers may contain relatively more fat than protein. Some nutritionists may attempt to provide milk replacers that attempt to mimic whole milk where the protein and fat on a dry matter basis are 26 percent and 31 percent respectively. In other cases, the milk replacer can have the fat percent be equal to the protein such as a 24 percent protein and 24 percent fat milk replacer or slightly higher like a 22 percent fat and 20 percent protein on a dry matter basis. In extremely cold weather feeding, a producer or nutritionist may elect to feed a milk replacer with very high fat, e.g., 20 to 25 percent, so that the animal receives additional energy. In warm weather, milk replacers with a low fat content, e.g., 16 to 20 percent, may be fed. If a milk source is known to contain very low levels of fat, it may be advantageous to supplement the milk powder or liquid with a high fat powder. For example, if a farm has an abundant supply of liquid whey or skim milk, this feed would need additional fat. In some implementations, fortifiers may be present in extenders and balancers.

Continuing with the particular example of the dietary target of about 0.75 lbs. total solids per feeding, with protein at about 24 to about 27 percent of total solids and fat at about 20 to about 23 percent of total solids, the additional nutrients may be calculated based on the amount of available whole milk. Where whole milk accounts for about ⅔ of the total solids in the liquid diet (e.g., 0.5 lbs. per feeding), and an analysis determines the whole milk contains protein at about 27 percent of solids and fat at about 29 percent of total solids, and the additional nutrient accounts for about ⅓ of the liquid diet (e.g., 0.25 lbs. per feeding), the additional nutrient in the form of a balancer or a milk replacer with about 24 percent protein and about 7 percent fat may be admixed with the whole milk to reach the dietary target. In some implementations, the protein: fat ratio of 1.0 or greater may additionally be used in the dietary target calculation.

The preceding example is not limiting with respect to the level of total solids, the level of whole milk and additional nutrient source in the admixture or the level of solids derived therefrom. For instance, the level of total solids per feeding may be about 0.50 pounds to about 3.0 pounds, including but not limited to 0.50, 0.75, 1.0, 1.25, 1.5, 1.75, 2.0, 2.25, 2.5, 2.75 or 3.0 pounds of total solids on a dry matter basis. Whole milk in the admixture may account for about 20 to about 90 percent (including but not limited to 20-30, 20-40, 20-50, 20-60, 20-70 or 20-80 percent), about 30 to about 90 percent (including but not limited to 30-40, 30-50, 30-60, 30-70 or 30-80 percent), about 40 to about 90 percent (including but not limited to 40-50, 40-60, 40-70 or 40-80 percent), about 50 to about 90 percent (including but not limited to 50-60, 50-70 or 50-80 percent), or about 60 to about 90 percent (including but not limited to 60-70 or 60-80 percent) of the admixture. Solids from whole milk may account for about 20 to about 90 percent (including but not limited to 20-30, 20-40, 20-50, 20-60, 20-70 or 20-80 percent), about 30 to about 90 percent (including but not limited to 30-40, 30-50, 30-60, 30-70 or 30-80 percent), about 40 to about 90 percent (including but not limited to 40-50, 40-60, 40-70 or 40-80 percent), about 50 to about 90 percent (including but not limited to 50-60, 50-70 or 50-80 percent), about 60 to about 90 percent (including but not limited to 60-70 or 60-80 percent), about 70 to about 90 percent (including but not limited to 70-80 percent) or about 80 to 90 percent of the total solids in the admixture. Conversely, solids from the additional nutrient source may account for the balance of the total solids in the admixture, such as about 10 to 80 percent (including but not limited to 10-20, 20-30, 30-40, 40-50, 50-60, 60-70, 10-30, 20-40, 30-50, 40-60, 50-70, 10-40, 20-50, 30-60, 40-70, 10-50, 20-60, 30-70, 10-60, 20-70, or 10-70 percent) of the total solids in the admixture.

The additional nutrients required to reach the animal dietary target may be admixed with the available whole milk and water. Water helps achieve a desired volume when the solids density of the admixture exceeds the target solids content in the diet. Mixing may occur on a daily basis, such as once per day, twice per day or three times per day, and may be based on the number of feedings the young animal is to receive per day. Prior to or after mixing, the whole milk may be pasteurized (e.g., using on farm pasteurization) or may re-pasteurized where the milk was previously pasteurized (e.g., when squeeze milk is used in the diet).

Because the composition of available whole milk may change, the composition may be analyzed on a regular basis so that adjustments can be made in admixing to achieve the desired dietary target(s). For instance, the milk composition may be analyzed each time a whole milk shipment is received. In addition or alternatively, the milk composition may be analyzed periodically over the course of a feeding program, such as daily; every other day; or multiple times per week, e.g., bi-weekly.

In addition, the volume of available whole milk may change resulting in the need to reformulate the young animal's liquid diet in order to reach the target diet. The available volume needed may change based on the number of young animals ingesting a liquid diet, the volume of milk received in a shipment, and/or the availability of hospital milk. In a particular example, the number of young animals ingesting the liquid diet, or their volume requirements, may change on a daily basis. For instance, animals beginning a weaning phase may require fewer feedings per day compared to a previous day; weaned animals may no longer require a whole milk-based diet; and/or young animals may die or may be removed from the feeding program which may be administered in a group feeding setting. When milk is shipped to a farm, the volume of milk may vary. depending on availability. Hospital milk volume may vary depending on the number of dairy cows producing hospital milk each day. Thus, while some liquid diets may contain 90 percent or more whole milk, the volume of available whole milk for use in feeding the young animal may vary based on availability, and may be as low as 20-30 percent; and recalculating the liquid diet may therefore be done on a regular basis. This recalculation ensures the animal consistently receives the nutrients needed to reach the target growth goal. Moreover, in certain cases, whole milk may be unavailable for a brief period during the feeding program, and the young animals may be required to ingest a liquid diet of milk replacers alone or in combination with other balancers, extenders or fortifiers. In this situation, the animal continues to benefit due to formulating the target diet with the same total solids, fat and protein as when the diet contains whole milk, and once whole milk is available, the whole milk is seamlessly incorporated back into the target diet while delivering a constant solids and nutrient level throughout the program.

Admixtures of whole milk and additional nutrients prepared according to the present disclosure may be regularly fed to the young animals prior to being weaned. Delivery of the admixture to the young animal may be according to conventional approaches including using a bucket, bottle or auto-feeder, Starter feed may be delivered using conventional approaches. Starter feed may contain about 18 to about 22 percent crude protein, may be texturized, pelleted and/or medicated. Typical forms of a starter are texturized and pelleted. Texturized starters are made up of whole grains that are easily identified and also contain a pellet that contains minerals, vitamins and protein. Pelleted starters are ground feed that is tightly compressed, and when used, it is preferred that these contain low levels of fines.

Continuing still with the particular example of the admixture containing the dietary target of about 0.75 lbs. total solids per feeding, with protein at about 24 to about 27 percent solids and fat at about 20 to about 23 percent of solids, it has been discovered that young animals, particularly calves, ingesting the admixture twice per day prior to weaning and once per day during weaning are caused to intake elevated levels of starter feed offered ad libitum. The elevated starter intake may be an increase of starter intake as a percentage of the total dry matter in the diet (e.g., the combination of dry matter from solids in the admixture and dry matter of the starter), an increased average daily starter intake, an increased overall dry matter intake and/or an increase daily dry matter intake until the young animal is weaned, as compared to young animals fed milk replacer alone, and/or as compared to young animals fed whole milk alone. The preceding example of a diet that results in improved performance is not limiting with respect to the particular total solids, fat and protein level in the target diet; and young animals, such as calves, fed the admixtures formulated according to the present disclosure may increase starter intake as a percentage of total dry matter intake until weaned by at least about 10 percent or about 15 percent as compared to young animals fed milk replacer alone, and/or by at least about 5 percent as compared to young animals fed whole milk alone. Young animals, such as calves, fed the admixtures of the present disclosure may increase average daily starter intake until weaned by at least about 30 percent or about 35 percent as compared to young animals fed milk replacer alone, and/or by at least about 15 percent or 20 percent as compared to young animals fed whole milk alone. Young animals, such as calves, fed the admixtures of the present disclosure may increase overall dry matter intake (by ingesting both starter and the admixture) and/or dry matter intake on a daily basis by at least about 15 percent or about 20 percent as compared to young animals fed milk replacer alone, and/or by at least about 10 percent as compared to young animals fed whole milk alone.

Due to the ingestion of the admixture and the elevated level of starter feed according to the present disclosure, the young animals may experience improved performance. For instance, young animals, such as calves, ingesting the admixtures and starter according to the present disclosure may increase average daily gain by at least about 15 percent or about 20 percent as compared to young animals fed milk replacer alone, and/or by at least about 3 percent as compared to young animals fed whole milk alone. In addition or alternatively, young animals, such as calves, may gain weight by at least about 15 or about 20 percent as compared to young animals fed milk replacer alone, and/or by at least about 3 percent as compared to young animals fed whole milk alone. In addition or alternatively, young animals, such as calves, may gain in hip height by at least about 15 or about 20 percent as compared to young animals fed milk replacer alone, and/or by at least about 3 percent as compared to young animals fed whole milk alone.

Moreover, the improved performance may extend past weaning, and ingestion of the admixture and the elevated level of starter feed according to the present disclosure, may result in animals experiencing increased average daily gain and increased gain in hip height 28 days or more after weaning.

It is believed that animals ingesting the admixture and starter feed according to the present disclosure do not experience negative health effects.

When non-saleable milk, such as hospital milk is used in combination with balancers, extenders and/or milk replacers, the cost per gain in height and/or weight may be markedly lower than the cost of feeding using milk replacer alone or saleable milk alone. Even where the cost per gain in height and/or weight is the same or more when animals are fed an admixture of whole milk and milk replacer and offered starter ad libitum, the increased starter intake and the resulting increased gain in weight and height can result in improvements in overall animal management because the animal may mature faster, reproduce faster, reach a weight for slaughter faster or combinations of these. Further, animals that have a more functional rumen as a result of incremental and total starter intake improvements have been shown to have a smoother and healthier transition into group pens.

According to additional implementations, calculating the amounts of each of the whole milk and other nutrients that are to be combined to reach on a target total solids, fat and/or protein level in the admixture involves using known compositions for the available whole milk and additional nutrient sources and known volume of available whole milk and solving for the volume of whole milk to be combined with the additional nutrients and water to reach the target(s). For instance, using a calculator to calculate the admixture content, the calculator may receive from a user the target solids, fat and/or protein for feeding the young animal or animals. The target(s) may be based on the goal of feeding the young animal and may be provided as a target range (e.g., full potential feeding and/or improving cost per gain). The targets may be presented as a range, so that the level of total solids, protein and/or fat calculated for the admixture falls within the target range. In some implementations, the calculator iteratively calculates various levels of the whole milk and additional nutrients until the calculations fall within the target range(s).

With respect to the known variables, for the available whole milk, the calculator may receive from the user the known level of total solids, solids non-fat, protein, fat, lactose, added water, or combinations, as well as the available volume of whole milk, and/or volume of whole milk to be fed per feeding. In some implementations, the whole milk entries may be segmented into different types of whole milk (e.g. saleable, skim milk, 1 percent, 2 percent, 4 percent or hospital milk) along with the corresponding known levels. The known levels may be analytical results generated from an electronic analyzer, which may be entered by the user into the calculator, or the calculator may be communicatively coupled to the analyzer.

For the known variables in the additional nutrient sources, the known protein, fat, total solids, or combinations, may be received into the calculator. The compositions may be known through analysis or labeling. The information may be entered by a user or the calculator may be communicatively coupled to a library of nutrient sources with known compositions available for selection.

Other known variables that may be entered into the calculator may include but are not limited to the number of young animals, the weight of the young animal or average weight of a group of young animals, the number of feedings per day and the volume per feeding may be received from the user. Because one or more of the aforementioned known variables may change regularly, updates may be received periodically such as daily; every other day; or multiple times per week, e.g., bi-weekly.

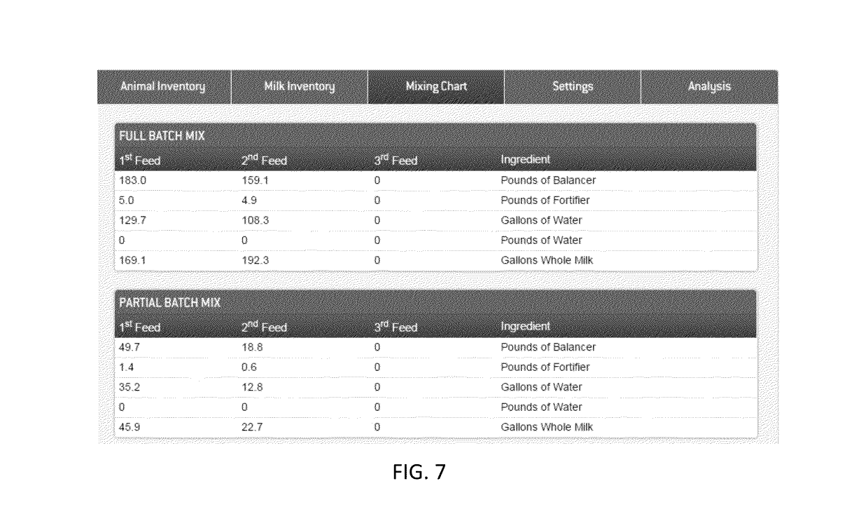

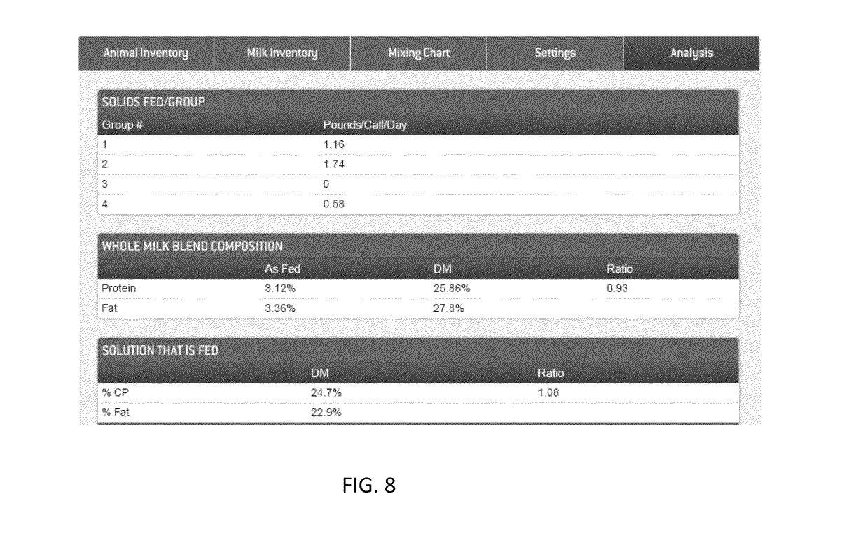

Using the received known variables and target(s), the calculator may calculate the amount of whole milk, additional nutrients and optionally water for admixing to reach the target(s). Each of the admixture components may be displayed on a graphical display (see e.g., FIGS. 6 and 7 described herein). For instance the displayed information may include the whole milk (e.g., by type if more than one type is available for admixing) and volume calculated (e.g., in quarts, liters, or gallons) for the admixture, the nutrient source by type and the weight (e.g., lbs. or kg.) calculated for the admixture, and the volume of water needed to reach the target(s) in the admixture. The additional nutrients may additionally or alternatively be displayed as the number of bags of the additional nutrient for admixing with whole milk and/or water. For instance, if 250 lbs. of a milk replacer is needed to reach the target admixture, and each bag of milk replacer weighs 50 lbs., the number of bags of milk replacer may be displayed as 5. Moreover, where the admixture is to be mixed in a batch mixer with a finite capacity, the admixture components may be broken into multiple batches where the total admixture exceeds the capacity of the batch mixer.

According to a particular example, the target diet with about 13 percent total solids (+/−0.5 percent), fat at about 19 to 22 percent of total solids, and protein at about 25 to 27 percent of total solids and 1200 gallons of an admixture may be entered into the calculator as targets. The available whole milk, such as 1100 gallons for a given period, with a fat content of 2.21 percent or 18.2 percent of total solids, protein content of 3.5 percent or 28.9 percent of total solids and a total solids of 12.11 percent; a first milk replacer with its fat and protein content, such as protein at about 5 percent of total solids, and fat at about 44 percent of total solids may be entered; and a second milk replacer with its fat and protein content, such as protein at about 26 percent of total solids and fat at about 6 percent of total solids may be received by the calculator. Using the known variables, the calculator may calculate the gallons of whole milk, pounds of each of the milk replacer and gallons of water for admixing to reach the targets. In this example, 1112 gallons of the available whole milk may be admixed with 158 pounds of the first milk replacer containing a high fat level and with 21 pounds of the second milk replacer containing a high protein level to reach 13 percent total solids and protein at 26.0 percent of total solids and fat at 21.1 percent of total solids, meaning each of the total solids, fat and protein fall within the target ranges. Additional water is added to achieve the final volume of 1200 gallons and 13 percent solids target.

In the preceding example, the calculator calculates a volume of whole milk that is lower than the available volume for admixing with the additional nutrients to reach the target(s). In this instance, the reserved whole milk may be available for admixing the following day or feeding.

The calculator may additionally or alternatively display the results as a volume of the admixture to be fed to each animal per day and/or per feeding; as volumes/amounts to be mixed in a batching process; and/or the results may be displayed using alternative units (e.g., SI or metric units such as grams/kilograms and liters).

As the known variables change over time (e.g., the next day or at the next whole milk shipment), the calculator may be updated with new values, such as a new fat, protein, solids non-fat, total solids, lactose, added water, or combinations in whole milk; available volume of whole milk; compositions of additional nutrients; and/or the number of young animals to be fed, the calculation may be re-run to reach the same target(s) but using a different admixture of whole milk and the additional nutrients.

An exemplary calculator may solve for the actual percent solids in the admixture using the following equation:

Actual percent solids=((gallons of whole milk×8.6×percent total solids in the whole milk)+pounds of first milk replacer+pounds of second milk replacer))/((gallons of whole milk×8.6)+pounds of first milk replacer+pounds of second milk replacer+(gallons of water×8.34));

where 8.6 is the pounds/gallon of whole milk (which may vary depending on the amount of fat and temperature);

and where 8.34 is the pounds/gallon of water.

To reach a target final total solids percent, the equation may be solved for each of the gallons of whole milk, gallons of water and the pounds of first and second milk replacer due to a known level of total solids in the milk replacers and a known level of total solids in the whole milk, for instance, as a result of using the electronic analyzer (e.g., an on-farm analyzer).

One exemplary way of solving for the fat as a percent of total solids in the admixture may be according to the following equation:

Final fat percent=((pounds of first milk replacer×percent fat in first milk replacer)+(pounds of second milk replacer×percent fat in second milk replacer)+(gallons of whole milk×8.6×(percent fat in whole milk/100)))/((gallons of whole milk×8.6×total solids percent)+pounds of first milk replacer+pounds of second milk replacer);

where 8.6 is the pounds/gallon of whole milk (which may vary depending on the amount of fat and temperature).

To reach a target final fat percent, the equation may be solved for each of the gallons of whole milk and the pounds of first and second milk replacer due to a known level of fat in the milk replacers and the whole milk, for instance, as a result of using the electronic analyzer.

An exemplary way of solving for protein as a percent of total solids in the admixture may be according to the following equation:

Final protein percent=((pounds of first milk replacer×percent protein in first milk replacer)+(pounds of second milk replacer×percent protein in second milk replacer)+(gallons of whole milk×8.6×(percent protein in whole milk/100)))/((gallons of whole milk×8.6×total solids percent)+pounds of first milk replacer+pounds of second milk replacer);

where 8.6 is the pounds/gallon of whole milk (which may vary depending on the amount of fat and temperature).

To reach a target final protein percent, the equation may be solved for each of the gallons of whole milk and the pounds of first and second milk replacer due to a known level of protein in the milk replacers and a known level of protein in the whole milk, for instance, as a result of using the electronic analyzer.

An exemplary way of solving for the volume of water to be added in the admixture may be according to the following equation:

Gallons of water=(Target volume−Gallons of whole milk)−((pounds of first milk replacer+pounds of second milk replacer)/13);

where it is assumed that 13 lbs. of milk replacer displaces one gallon of volume; however, this number may be variable depending on the composition of the additional nutrients (e.g., fat, protein and lactose).

While the preceding describes first and second milk replacers in the admixture, other additional nutrients including balancers, extenders and/or fortifiers may additionally or alternatively be used to reach the target(s) and calculated using similar approaches. In addition, one or more of above equations may be modified based, for instance, on whether other nutrient sources with fat and/or protein are used in the admixture. Providing two or more nutrient sources with different nutrient contents and ratios may be preferred for admixing with whole milk. For instance, when the whole milk contains a low amount of fat, e.g., less than 2 percent or about 16 percent of dry matter, a nutrient source with a high fat content (e.g., 30 to 40 percent fat) and high fat to protein ratio (e.g., 5 to 10 parts fat per one part of protein) may be used to increase the fat content relative to the protein content; when the whole milk contains a relatively low amount of protein, e.g., about 2.5 percent or greater or about 20 percent of dry matter, a nutrient source with a high protein content (e.g., 30 to 40 percent protein) and high protein to fat ratio (e.g. 5 to 10 parts protein per one part of fat) may be used to increase the protein content relative to the fat content; and further, both nutrient sources may be used in combination to simultaneously balance a total solids content of the admixture.

When the volume to be ingested per animal is known, the total solids, protein and fat to be ingested may be calculated. For instance, where the animal is to ingest a volume of 96 ounces per feeding (3 US quarts), and the total solids content of the admixture is 13 percent, the weight of total solids is 13.44 ounces (0.13×(8.6 lbs./gallon/4 quarts/gallon)×3 quarts) or 0.84 lbs. Where the fat content is 21 percent of total solids, the weight of the fat ingested is 2.82 ounces (0.21×0.13×(8.6 lbs./gallon/4 quarts/gallon)×3 quarts) or 0.18 lbs. Where the protein content is 24 percent of total solids, the weight of protein ingested per feeding is 3.2 ounces (0.24×0.13×(8.6 lbs./gallon/4 quarts/gallon)×3 quarts) or 0.20 lbs. By targeting a total solids, fat and/or protein content for the animal per feeding or per day, the young animal may ingest a consistent diet even when the composition of the whole milk varies, which would otherwise result in the animal ingesting a variable total solids, fat and protein level even when a consistent volume of whole milk is provided.

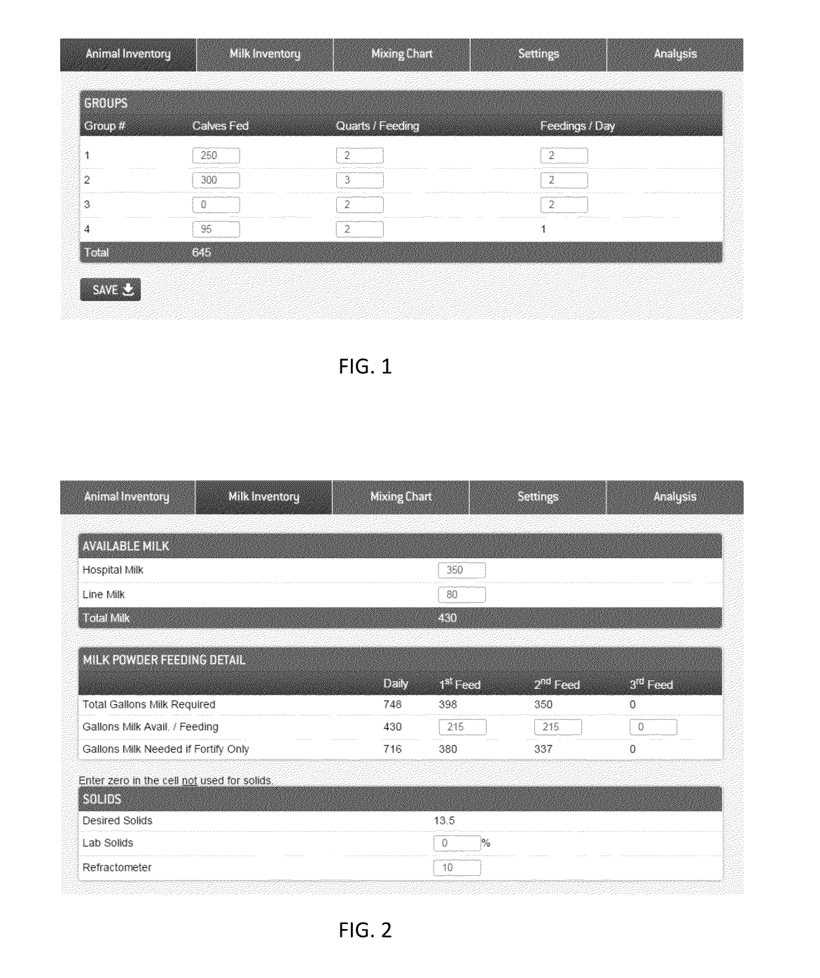

FIGS. 1-9 provide exemplary screen shots of an embodiment of a user interface that may be used to display information related to calculating a feed ration or target diet for the young animal(s), according to certain implementations. With reference to FIG. 1, the screen shot illustrates an animal inventory listing the different groups of young animals to be fed, the number of young animals per group, the volume fed per animal, and the number of feedings per animal per day. The animal distribution and volume fed in this figure represents a typical herd where young animals, such as calves, are started at a lower feeding rate (group 1), e.g., of 2 quarts per feeding twice per day; then increase to a larger volume (group 2), e.g., of 3 quarts per feeding twice per day; and then decrease to smaller volume and once daily feeding at weaning (group 4).

With reference to FIG. 2, the screen shot illustrates a milk inventory of available whole milk. The milk inventory may be predetermined by available milk from the hospital and additional milk from the saleable “line” milk that may be selected to be added to diet. The whole milk is allocated to each feeding and may be equal allocations or proportioned, as desired. The desired solids are selected by the user based on the feeding goal of the animal. The total solids present in the available whole milk may be either estimated with a refractometer or measured with the use of the ultrasonic device. With reference to FIG. 3, the screen shot lists a variety of whole milk sources, their available volume, and their protein and fat content, which may be used in combination with the additional nutrient sources in the admixture. These compositions may be estimated or actual values entered from an ultrasonic analyzer or refractometer, for example.

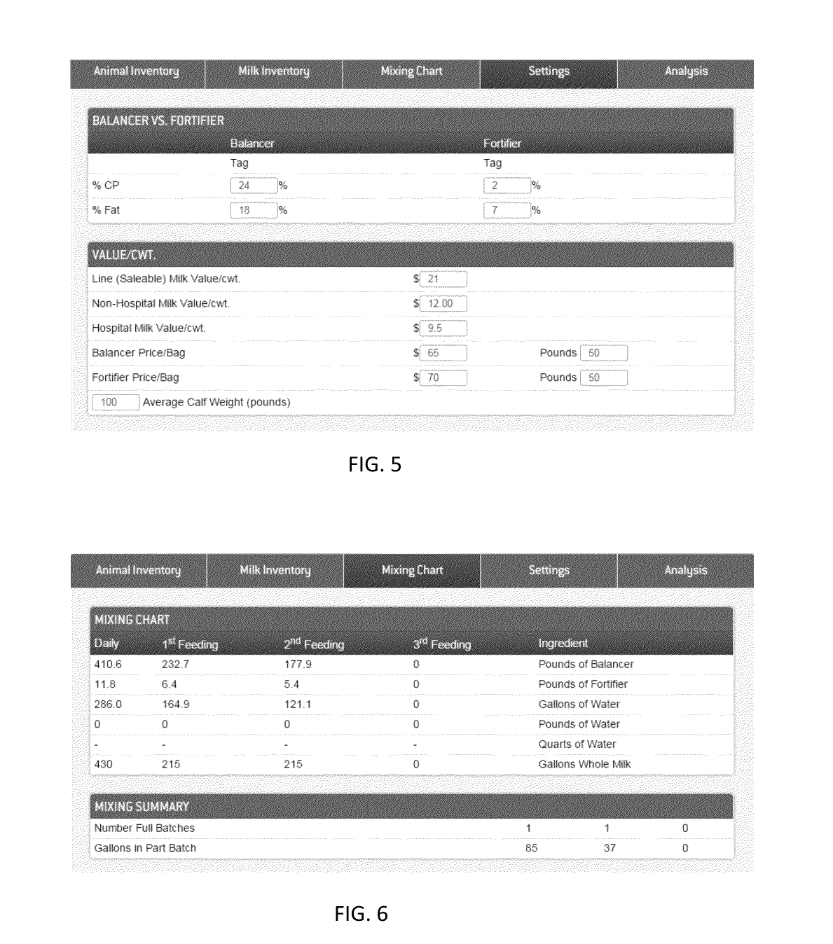

With reference to FIG. 4, the screen shot lists the settings that may be used for calculating the feed ration or target diet. The settings may include target solids for use in calculating the admixture component levels. A fortifier setting may be used to allocate fortifier to each feeding by percentage and the dose of the fortifier. In addition, a mixer size may be entered for batch mixing. The screen shot of FIG. 5 lists additional settings and include fields for entering the nutrient content of the additional nutrients such as the level of fat as a percentage of total solids and the level of protein as a percentage of total solids. Other settings may include the cost of the whole milk and additional nutrients as well as the average weight of the young animal.

FIG. 6 illustrates a screen shot of a mixing chart listing the pounds, gallons or quarts of inclusion of each component to be admixed per feeding as well as batch summary. The mixing chart may be generated based on the target(s) selected for the young animal(s) (e.g., the total solids, fat, protein entered into the user interfaces illustrated in the FIGS.) in view of the known parameters (e.g., the number of young animals to be fed, number of feedings, volume to be fed, volume of available whole milk, total solids, fat and protein present in the available whole milk and in the additional nutrients entered into the user interfaces illustrated in the FIGS.). The screen shot of FIG. 7 illustrates the amount of inclusion per hatch for each of the admixture components for a full and partial batch and may be particularly useful in a large herd setting. While FIGS. 6 and 7 list a balancer and a fortifier for admixing with water and whole milk, the mixing chart may additionally or alternatively list other nutrient sources.

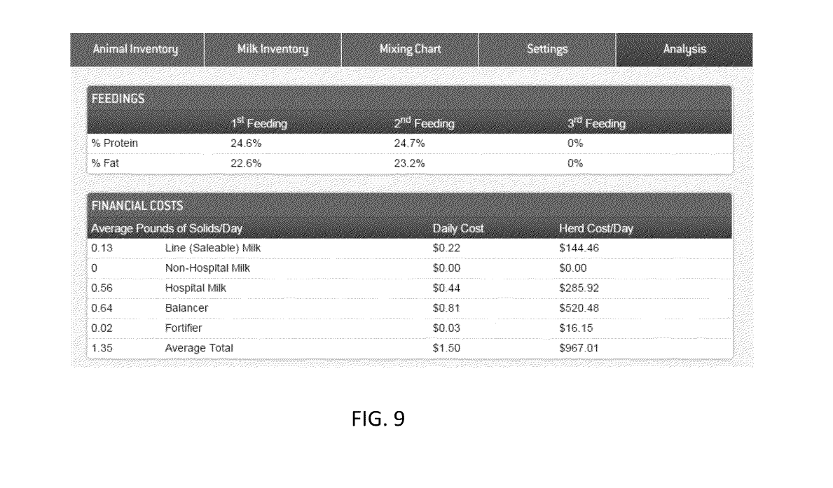

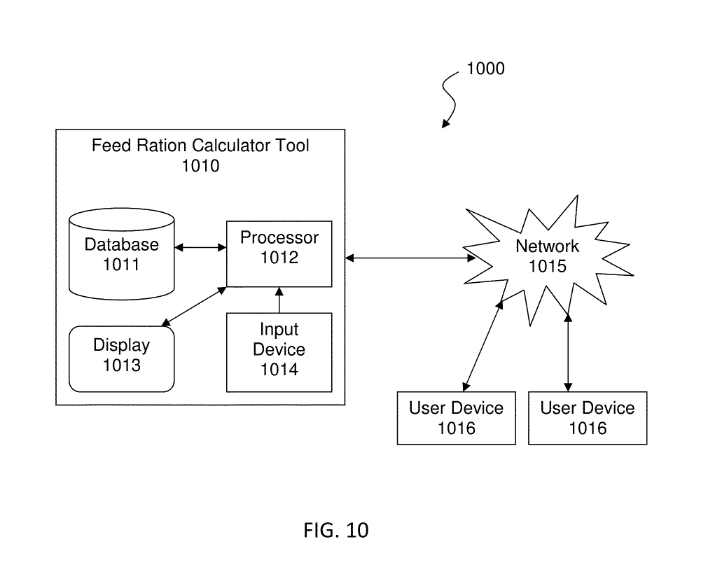

FIG. 8 illustrates a screen shot of an analysis view of the total solids fed per calf per day by group based on the admixture calculated. The analysis view additionally displays the whole milk composition, which enables the user to compare the final admixture composition with the whole milk composition. In FIG. 8, the final admixture contains a lower protein and fat content and a higher protein to fat ratio compared to an available blend of whole milk alone. For instance, the admixture may contain a ratio of protein to fat that is greater than 1. This may be desirable when the goal of feeding is to increase dry feed (e.g., starter) intake or feeding and in conventional and enhanced feeding settings. FIG. 9 illustrates a screen shot of an analysis view of the level of fat and protein fed per feeding and the daily cost per calf and herd cost per day.

According to further implementations, the amount of weight the animal is expected to gain may be predicted using the dietary intake of the admixture (e.g. pounds of total solids, fat and protein ingested) alone or in combination with starter along with the weight or average weight of the young animal(s), and the ambient temperature (e.g., thermoneutral temperatures for a new born calf is about 50-78° F. and for a one month old is about 32-78° F., and temperatures below the lower thresholds results in the calf expending energy to maintain its body temperature resulting in a decreased predicted gain. Conversely, the calf must expend energy to maintain its body temperature when the ambient temperature is above the higher threshold.). Because the present disclosure provides methods for delivering a consistent level of nutrients to the young animal via the admixture, the animal weight gain may be more accurately predicted.

In some approaches, the weight or average weight of the young animals may be used to calculate a level of a nutrient to be fed to the young animal, for instance, when the nutrient is beneficial for the animal within a certain range per unit weight of the animal, and may lose its benefit or be harmful to the animal at levels outside of the range. This may be the case for certain fortifiers such as medicated fortifiers or milk replacers.

In some approaches, the cost of the whole milk per unit (e.g., per hundredweight or 100 lbs.) based on type and the cost of the additional nutrient sources per unit may be entered where the user compares the cost of feeding differing admixtures, tracks the cost of feeding, tracks the cost of feed per unit of weight or height gain, and so on.

As described, the calculated amounts may be mixed and the admixture fed to the young animal.

In view of the foregoing, aspects of the methods of the present disclosure may be implemented using a computer or computer components such as a processor and a memory. For example, analysis of whole milk may be performed using a computerized analysis device including sensor components for sensing and correlating sensed information with milk compositions, and the results may be used as input in a calculator for formulating or reformulating a diet such as a feed ration for a young animal, such as a calf. A formulation calculator may be embodied in software and/or hardware, and a computer processor may execute instructions for receiving and analyzing the input and for reformulating the feed ration based on the received and analyzed data. Accordingly, aspects of the present disclosure may be provided as a computer program product, or software, that may include a data storage unit provided as non-transitory machine-readable medium having stored thereon instructions, which may be used to specially program a computer system (or other electronic devices) to perform a process according to the present disclosure. The computer system(s) may be specially configured with sensors for analysis of whole milk and/or may be configured to receive information derived from the sensors and may enable the whole milk composition to be known in real time to deliver a targeted diet to the young animal. The computer system(s) may include a portable device such as a smart phone, a tablet or a laptop. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on. Accordingly, the methods provided herein may be implemented on a computer system communicatively coupled to other computer systems, and/or on a communicatively coupled network of computers, having processing units, memory storage units, communications units, and communication links.

By means of example and not limitation, FIG. 10 provides a block diagram of a computer system 1000 for receiving information necessary to calculate a feed ration or target diet for the young animal(s) and displaying the information on a visual display. The system 1000 includes a feed ration calculator tool 1010 with a database 1011, a processor 1012, a display 1013 and an input device 1014 (e.g. a keyboard, mouse, touch screen or remote control). In some implementations, the feed ration calculator tool 1010 may be one or more computers specially programmed as described herein. In some aspects, the system 1000 may be communicatively coupled to a communications network 1015 for enabling a number of user devices 1016 to enter user input and receive information on the predicted spray performance of the selected from the system 1000.

In the present disclosure, some of the method steps may be implemented as sets of instructions or software readable by a specially programmed device for calculating diets of admixtures of whole milk and additional nutrient sources. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them, and variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of formulating a diet for a young animal in a feeding program, the method comprising:
in a location where young animals are fed, analyzing available whole milk for a level of total solids, protein as a percentage of total solids and fat as a percentage of total solids, and determining a volume of whole milk available for feeding to the young animal;
identifying a diet to be fed to the young animal, the diet comprising at least one target selected from a total solids target, a fat as a percentage of total solids target or a protein as a percentage of total solids target, wherein the at least one target is different from a corresponding level of total solids, fat or protein in the analyzed whole milk;
using the analysis results of the analyzed whole milk to calculate an amount of at least one additional nutrient source for incorporating with the available whole milk to reach the at least one target;
calculating an amount of water for incorporating with the available whole milk to reach the at least one target;
admixing the calculated amounts of the at least one additional nutrient source and water with at least a portion of the available volume of whole milk in the location to reach the at least one target; and
feeding the admixture to the young animal,
wherein, over a course of the program, the compositional analysis results of the available whole milk or an available volume of the whole milk varies such that the amounts calculated dynamically change.

2. The method of claim 1, wherein the at least one target comprises each of the total solids target, the fat as a percentage of total solids target and the protein as a percentage of total solids target, and wherein at least one of said targets is different from a corresponding level of total solids, protein as a percentage of total solids or fat as a percentage of total solids in the whole milk.

3. The method of claim 2, wherein the at least one additional nutrient source comprises a first additional nutrient source having an elevated fat content and a second additional nutrient source having an elevated protein content, wherein a composition of the first nutrient source is different from the second nutrient source, and wherein the calculated amount of the at least one additional nutrient source comprises an amount of each of the first and second nutrient sources.

4. The method of claim 3, wherein at least one of the first nutrient source or the second nutrient source is a milk replacer.

5. A method of formulating a target diet for a young animal in a feeding program, the method comprising:
in a location where young animals are fed, analyzing available whole milk for a level of total solids, protein as a percentage of total solids and fat as a percentage of total solids, and determining a volume of whole milk available for feeding to the young animal;
identifying a diet to be fed to the young animal, the diet comprising a total solids target that is different from the total solids in the analyzed whole milk;
using the analysis results of the analyzed whole milk to calculate an amount of at least one additional nutrient source for incorporating with the available whole milk to reach the total solids target;
calculating an amount of water for incorporating with the available whole milk to reach the total solids target;
admixing the calculated amounts of the at least one additional nutrient source and water with at least a portion of the available volume of whole milk in the location to reach the total solids target; and
feeding the admixture to the young animal,
wherein the compositional analysis results of the available whole milk or an available volume of the whole milk varies over a course of the program such that the amounts calculated dynamically change over the course of the program.

6. The method of claim 5, wherein the step of analyzing uses an ultrasonic analyzer.

7. The method of claim 5, wherein the diet further comprises at least one of a fat as a percentage of total solids target or a protein as a percentage of total solids target.

8. The method of claim 7, wherein the at least one additional nutrient source comprises a first additional nutrient source having an elevated fat content and a second additional nutrient source having an elevated protein content, wherein a composition of the first nutrient source is different from the second nutrient source, and wherein the calculated amount of the at least one additional nutrient source comprises an amount of each of the first and second nutrient sources.

9. The method of claim 8, wherein at least one of the first nutrient source or the second nutrient source is a milk replacer.

10. The method of claim 5, wherein a nutrient requirement of the animal in the program changes over the course of the program such that the diet dynamically changes.

11. The method of claim 5, wherein the additional nutrient source comprises an extender with a blend of protein and fat.

12. The method of claim 5, wherein the additional nutrient source comprises a fortifier with a blend of vitamins and minerals.

13. The method of claim 5, wherein the additional nutrient source comprises a balancer with a blend of protein and fat in which a protein level is different from a fat level.

14. The method of claim 5, further comprising calculating a predicted amount of weight the young animal is to gain by ingesting the admixture, wherein the predicted amount is calculated using a volume of admixture to be ingested, a weight or an average weight of the young animal and an ambient temperature.

15. A method of formulating liquid feed for a calf nutrition program for a group of calves, the method comprising:
receiving compositional analysis results of available whole milk, wherein the compositional analysis results comprise at least two of total solids, protein as a percentage of total solids and fat as a percentage of total solids, density, added water or lactose;
calculating an amount of an additional nutrient source for incorporating with the available whole milk to reach a dietary target, the dietary target comprising at least two targets selected from total solids, protein as a percentage of total solids and, fat as a percentage of total solids or lactose, and the additional nutrient source comprising one or more of a milk replacer, an extender, a fortifier, or a balancer; and
mixing the calculated amount of the additional nutrient source with the available whole milk to reach the dietary target,
wherein, over a course of the program, the compositional analysis results of the available whole milk or an available amount of the whole milk varies such that the amount calculated dynamically changes.

16. The method of claim 15, wherein the additional nutrient source comprises a high fat milk replacer and a high protein milk replacer with a composition that is different from the high fat milk replacer, and wherein the calculated amount of the additional nutrient source comprises an amount of each of the high fat milk replacer and the high protein milk replacer.

17. The method of claim 15, wherein the number of calves in the group of calves changes over the course of the program such that amounts mixed dynamically changes.
